(19) United States
(12) Patent Application Publication
(10) Pub. No.: US 2018/0120610 A1
(43) Pub. Date: May 3, 2018

(54) LIQUID CRYSTAL DISPLAY DEVICE AND METHOD OF MANUFACTURING SAME

(71) Applicant: Panasonic Liquid Crystal Display Co., Ltd., Himeji-shi (JP)

(72) Inventor: Kikuo ONO, Ibaraki (JP)

(21) Appl. No.: 15/858,467

(22) Filed: Dec. 29, 2017

Related U.S. Application Data
(63) Continuation of application No. PCT/JP2015/003262, filed on Jun. 29, 2015.

(51) Int. Cl. G02F 1/1343; G02F 1/1362

(52) U.S. Cl. CPC G02F 1/1343; G02F 1/136286

(57) ABSTRACT

A liquid crystal display device having one of the substrates including: gate signal lines extending in a row direction; data signal lines extending in a column direction; pixel electrodes and thin-film transistors, which are disposed according to pixels arrayed in the row direction and the column direction; a first insulating film formed between the pixel electrodes and the thin-film transistors; and a common electrode disposed opposite to the pixel electrodes on a liquid crystal layer side. The pixel electrodes are directly formed on a transparent substrate constituting the one of the substrates. In each of the pixels, the pixel electrode is electrically connected to a conduction electrode of the thin-film transistor through a first contact hole formed in the first insulating film, and the conduction electrode and the pixel electrode overlap each other in a plan view in a region where the first contact hole is formed.

### CROSS-REFERENCE TO RELATED APPLICATION

This application is a bypass continuation of international patent application PCT/JP2015/003262, filed on Jun. 29, 2015 designating the United States of America. The entire disclosure of this international application is incorporated herein by reference in their entirety.

### TECHNICAL FIELD

The present disclosure relates to a liquid crystal display panel, especially a liquid crystal display panel of an In Plain Switching (IPS) mode and the method for manufacturing the same.

### BACKGROUND

A liquid crystal display device of an IPS mode in a prior art (for example, see, Japanese Unexamined Patent Application Publication No. 2012-113090) has a configuration in which a pixel electrode and a common electrode are formed in each liquid crystal layer-side pixel region of at least one of a pair of substrates placed opposite to each other via a liquid crystal layer. In this configuration, an electric field (lateral electric field) in a direction parallel to the substrate is generated between the pixel electrode and the common electrode, and the lateral electric field is applied to the liquid crystal layer to drive the liquid crystal. An amount of light passing through a region between the pixel electrode and the common electrode is thus controlled to display an image. The liquid crystal display device of the IPS mode has an advantage of less change in display even when being viewed obliquely with respect to a display surface. In other words, the liquid crystal display device of the IPS mode has an advantage that is superior in so-called wide viewing angle characteristics.

However, the liquid crystal display device in the prior art may have a problem, for example, a short circuit since a pixel electrode and a data signal line, because they are formed in proximity to each other in the same layer. It can be considered that an insulating layer is interposed between the pixel electrode and the data signal line in order to prevent the short circuit between the pixel electrode and the data signal line. However, there is another problem in this case that a process of manufacturing the liquid crystal display device becomes complicated.

The present disclosure has been made in view of the above circumstances, and an object thereof is to prevent the short circuit between a pixel electrode and a data signal line and to simplify a manufacturing process, as to a liquid crystal display device of an IPS mode.

### SUMMARY

In one general aspect, the instant application describes a liquid crystal display device having one of the substrates including: gate signal lines extending in a row direction; data signal lines extending in a column direction; pixel electrodes and thin-film transistors, which are disposed according to pixels arrayed in the row direction and the column direction; a first insulating film formed between the pixel electrodes and the thin-film transistors; and a common electrode disposed opposite to the pixel electrodes on a liquid crystal layer side. The pixel electrodes are directly formed on a transparent substrate constituting the one of the substrates. In each of the pixels, the pixel electrode is electrically connected to a conduction electrode of the thin-film transistor through a first contact hole formed in the first insulating film, and the conduction electrode and the pixel electrode overlap each other in a plan view in a region where the first contact hole is formed.

A part of the conduction electrode may be formed in the first contact hole, and directly connected to the pixel electrode.

A second insulating film disposed between the plurality of thin-film transistors and the common electrode may be further formed in the one of the substrates. The conduction electrode and the common electrode may overlap each other in a plan view in the region where the first contact hole is formed.

The one of the substrates may further include a second insulating film disposed between the plurality of thin-film transistors and the common electrode and a plurality of common wires electrically connected to the common electrode. The plurality of common wires may be electrically connected to the common electrode through a second contact hole formed in the first insulating film and a third contact hole formed in the second insulating film.

The second contact hole and the third contact hole may overlap each other in a plan view.

A connection electrode may be formed in the second contact hole, and the plurality of common wires may be electrically connected to the common electrode through the connection electrode.

A plurality of transparent electrodes may be directly formed on the transparent substrate. The plurality of transparent electrodes may include a plurality of first transparent electrodes and a plurality of second transparent electrodes. The plurality of first transparent electrodes may be formed as the plurality of pixel electrodes. The plurality of gate signal lines may be directly formed on the plurality of second transparent electrodes.

A plurality of transparent electrodes may be directly formed on the transparent substrate. The plurality of transparent electrodes may include a plurality of first transparent electrodes, a plurality of second transparent electrodes, and a plurality of third transparent electrodes. The plurality of first transparent electrodes may be formed as the plurality of pixel electrodes. The plurality of gate signal lines may be directly formed on the plurality of second transparent electrodes. The plurality of common wires may be directly formed on the plurality of third transparent electrodes.

In another general aspect, a method for manufacturing a liquid crystal display device, the method including: forming a plurality of pixel electrodes on a transparent substrate; forming a first insulating film such that the first insulating film covers the plurality of pixel electrodes; forming a first contact hole in the first insulating film; and forming a conduction electrode of a thin-film transistor on the first insulating film and in the first contact hole such that a part of the conduction electrode overlaps the pixel electrode in a plan view in a region where the first contact hole is formed.

The above general aspect may include one or more of the following features.

In the forming of the first contact hole, a semiconductor layer of the thin-film transistor and the first contact hole may be formed in one photoresist process.

In another general aspect, a method for manufacturing a liquid crystal display device, the method further including: forming a transparent electrode material on a transparent substrate; forming a plurality of common wires, a plurality of gate signal lines, and a plurality of pixel electrodes by patterning the transparent electrode material; forming a first insulating film such that the first insulating film covers the plurality of common wires, the plurality of gate signal lines, and the plurality of pixel electrodes; forming a first contact hole and a second contact hole in the first insulating film; forming a conduction electrode of a thin-film transistor on the first insulating film and in the first contact hole; forming a connection electrode on the first insulating film and in the second contact hole; forming a second insulating film such that the second insulating film covers the thin-film transistor and the connection electrode; forming a third contact hole in the second insulating film above the connection electrode; and forming a common electrode on the second insulating film and in the third contact hole such that the common electrode covers the conduction electrode and the pixel electrode in a plan view in a region where the first contact hole is formed, and such that the common electrode covers the connection electrode in a plan view in a region where the third contact hole.

The above general aspect may include one or more of the following features.

In the forming of the first contact hole and the second contact hole, a semiconductor layer of the thin-film transistor, the first contact hole, and the second contact hole may be formed in one photoresist process.

With the configuration of the liquid crystal display device according to the present disclosure, it is possible to prevent the short circuit between the pixel electrode and the data signal line and to simplify a manufacturing process, as to a liquid crystal display device of an IPS mode.

### BRIEF DESCRIPTION OF THE DRAWINGS

FIG. 1 is a plan view schematically showing an overall configuration of a liquid crystal display device according to the present disclosure;

FIG. 2 is a plan view showing a configuration of one pixel;

FIG. 3 is a cross-sectional view taken along line 3-3′ of FIG. 2;

FIG. 4 is a sectional view taken along line 4-4′ of FIG. 2;

FIG. 5A is a plan view of one pixel after an end of a first photoresist process;

FIG. 5B is a cross sectional view taken along line b-b′ of FIG. 5A;

FIG. 6A is a plan view of one pixel after developing a photoresist in a second photoresist process;

FIG. 6B is a cross sectional view taken along line b-b′ of FIG. 6A;

FIG. 7A is a plan view of one pixel after the end of the second photoresist process;

FIG. 7B is a cross-sectional view taken along line b-b′ of FIG. 7A;

FIG. 8A is a plan view of one pixel after the end of a third photoresist process;

FIG. 8B is a cross-sectional view taken along line b-b′ of FIG. 8A;

FIG. 9A is a plan view of one pixel after an end of a fourth photoresist process;

FIG. 9B is a cross sectional view taken along line b-b′ of FIG. 9A;

FIG. 10A is a plan view of one pixel after an end of a fifth photoresist process; and

FIG. 10B is a cross sectional view taken along line b-b′ of FIG. 10A.

### DETAILED DESCRIPTION

An embodiment of the present application is described below with reference to the drawings. The embodiment of the present application takes a liquid crystal display device of an IPS mode as an example of a display device of the present application. However, the present application is not limited thereto.

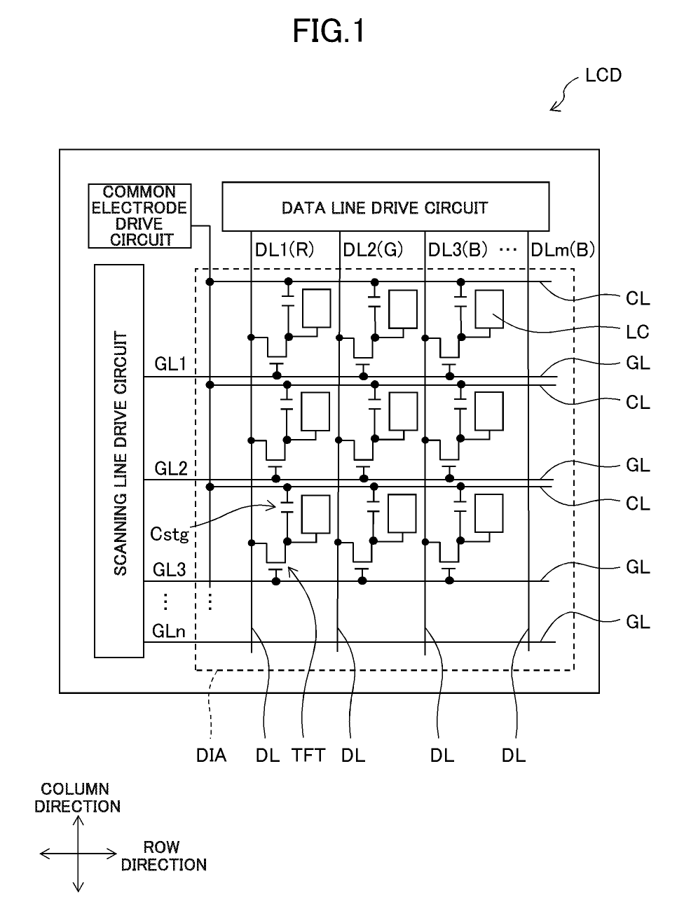

FIG. 1 is a plan view schematically showing an overall configuration of a liquid crystal display device according to the present embodiment. The liquid crystal display device LCD has an image display region DIA and a drive circuit region for driving the image display region DIA. In the image display region DIA, each of pixel regions surrounded by neighboring gate signal lines GL (scanning lines) and neighboring data signal lines DL are arranged in a matrix in a row direction and a column direction. Note that a direction in which the gate signal lines GL extend is the row direction, and a direction in which the data signal lines DL extend is the column direction.

An active matrix display is performed in each pixel region. More specifically, gate voltage is supplied from a scanning line drive circuit to gate signal lines GL1, GL2, . . . , GLn, data voltage is supplied from a data line drive circuit to data signal lines DL1, DL2, . . . , DLm, and common voltage (common voltage) is supplied from a common voltage drive circuit to a common electrode CIT. The data voltage is supplied to a pixel electrode PIT by turning ON/OFF a thin-film transistor TFT according to the gate voltage.

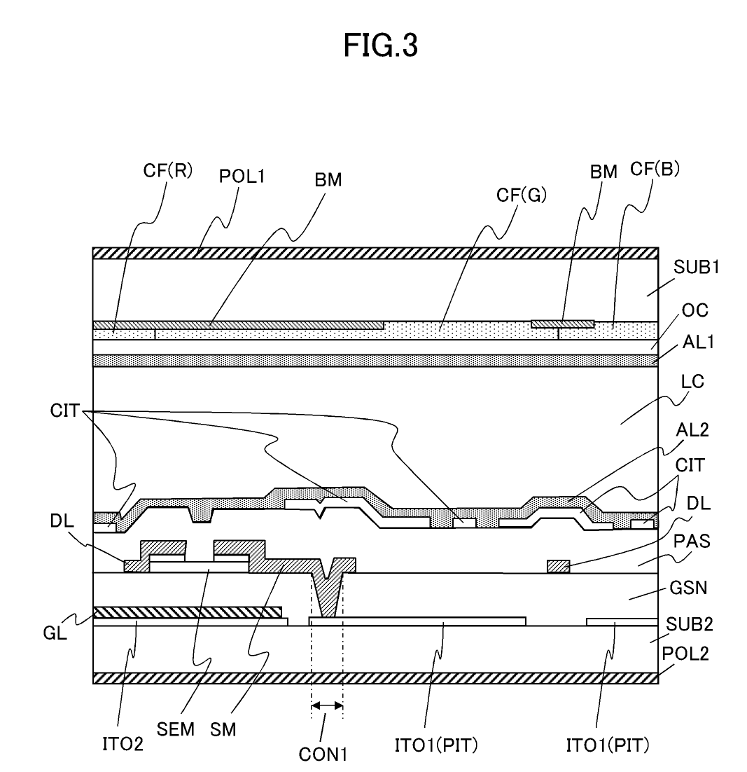

In each pixel region, a holding capacitance Cstg is formed in order to prevent a voltage drop in a liquid crystal layer LC. The holding capacitance Cstg is formed in a region where the pixel electrode PIT and the common electrode CIT overlap each other through insulating films (first insulating film, second insulating film) (see FIG. 3). The common voltage is supplied from the common electrode drive circuit to the common electrode CIT formed in the image display region DIA. The common electrode CIT and a plurality of common wires CL to reduce the resistance of the common electrode CIT are electrically connected to each other.

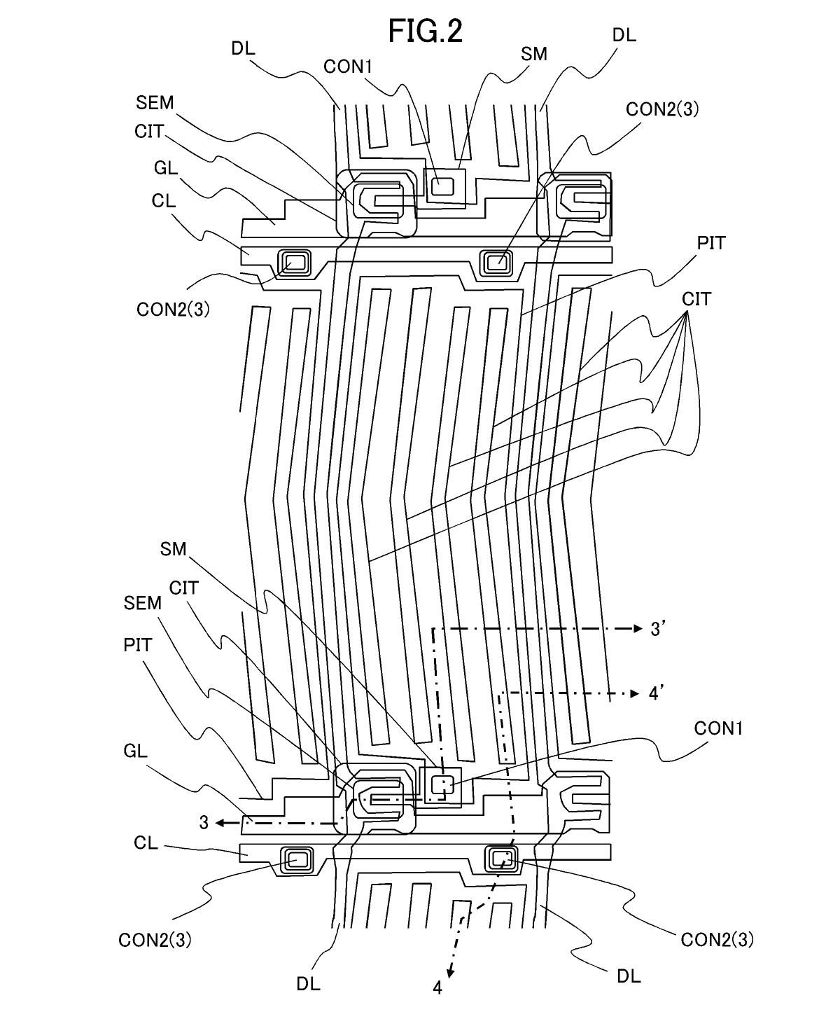

FIG. 2 is a plan view showing a configuration of one pixel. FIG. 2 shows one pixel region surrounded by adjacent two gate signal lines GL and adjacent two data signal lines DL and a part of a pixel region adjacent thereto. FIG. 2 shows a plane pattern of a thin-film transistor substrate (TFT substrate).

In each pixel region, a pixel electrode PIT is formed on the inside of adjacent two gate signal lines GL and adjacent two data signal lines DL. In common with the pixel regions, a common electrode CIT is formed. The common electrode CIT is provided with slits (openings) so as to correspond to the pixel regions. A part of a data signal line DL and a part of a source electrode SM (conduction electrode) of a thin-film transistor TFT overlap with a semiconductor layer SEM in a plan view. The pixel electrode PIT is electrically connected to the source electrode SM through a first contact hole CON1 (through-hole). The common wire CL is formed so as to extend in the row direction in parallel with the gate signal line GL. The common wire CL is electrically connected to the common electrode CIT through a second contact hole CON2 and a third contact hole CON3. In FIG. 2, the common wire CL and the common electrode CIT are electrically connected on a one pixel basis; however, the present disclosure is not limited thereto. The common wire CL and the common electrode CIT may be electrically connected on a plural pixels basis.

Here, a driving method of the liquid crystal display device LCD will be briefly described. The gate signal line GL is formed of a metal layer with low resistance, and gate voltage for scanning are applied from the scanning line drive circuit. Further, the data signal line DL is formed of a metal layer with low resistance, and data voltage for image is applied from the data line drive circuit. When gate-on voltage is applied to the gate signal line GL, the semiconductor layer SEM of the thin-film transistor TFT has a low resistance, and the data voltage applied to the data signal line DL is transferred, through the source electrode SM formed of a low-resistance metal layer, to the pixel electrode PIT electrically connected to the source electrode SM.

A common voltage is applied from the common electrode drive circuit through the common wire CL to the common electrode CIT. The common electrode CIT overlaps with the pixel electrode PIT via insulating films (first insulating film, second insulating film). The common electrode CIT is formed with a slit in one pixel region. Through the slit of the common electrode CIT, the liquid crystal layer LC is driven by an electric field for driving from the pixel electrode PIT to the common electrode CIT via the liquid crystal layer LC, and an image is displayed. A color display is realized by applying desired data voltage to data signal lines DL1(R), DL2(G), and DL3(B) connected to the pixel electrodes of the respective pixel regions corresponding to red (R) color, green (G) color, and blue (B) color formed in a vertical stripe color filter.

The shape of the slit of the common electrode CIT is not particularly limited, and may be a slender shape. Alternatively, the slit may be a typical opening having a rectangular shape, an ellipse shape, or the like. The width of the slit may be larger or may be smaller than a distance between adjacent slits.

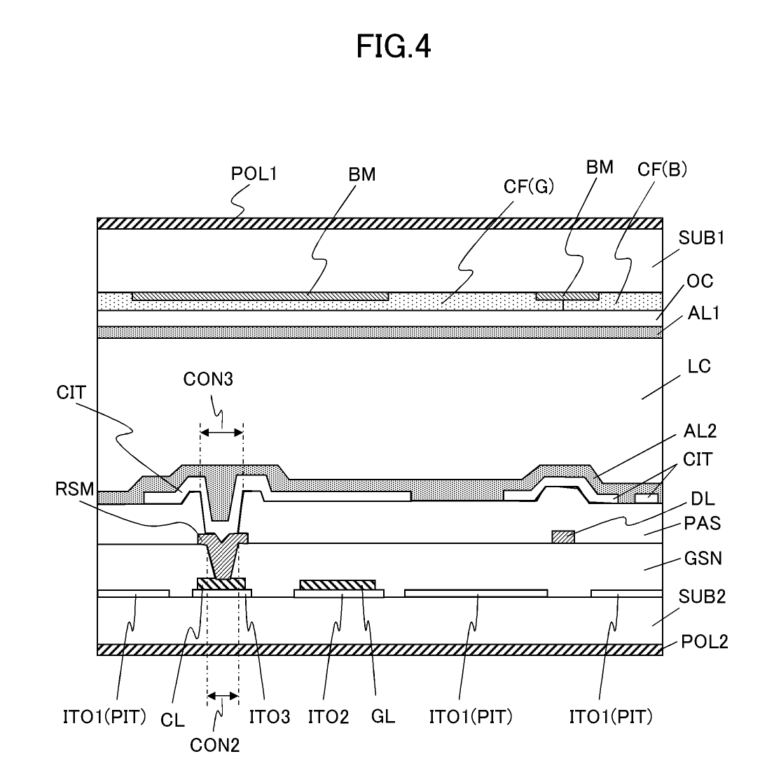

Next, a cross-sectional structure of a pixel will be described below. FIG. 3 shows a cross-sectional view taken along line 3-3′ of FIG. 2. And FIG. 4 is a sectional view taken along line 4-4′ of FIG. 2.

The liquid crystal display device LCD includes a color filter substrate (CF substrate), a TFT substrate, and a liquid crystal layer LC which is interposed between both the substrates. The liquid crystal layer LC is enclosed with positive-type liquid crystal molecules (not shown) where the long axes of liquid crystal molecules are aligned along an electric field direction.

A transparent electrode is formed on a second transparent substrate SUB2 (glass substrate) of the TFT substrate. The transparent electrode is configured to include first transparent electrodes ITO1, second transparent electrodes ITO2, and third transparent electrodes ITO3 obtained in such a manner that a transparent electrode material ITO (indium-tin oxide) is subjected to pattern processing and is separately designed. Each of the first transparent electrodes ITO1 is formed on a pixel basis and is formed as a pixel electrode PIT. The second transparent electrodes ITO2 extend in the row direction and are arranged at regular intervals in the column direction, and the gate signal lines GL are directly formed on the second transparent electrodes ITO2. The third transparent electrodes ITO3 extend in the row direction and are arranged at regular intervals in the column direction, and the common wires CL are directly formed on the third transparent electrodes ITO3. A gate insulating film GSN (first insulating film) is formed so as to cover the pixel electrode PIT, the gate signal lines GL, and the common wires CL. Above an end of the pixel electrode PIT (liquid crystal layer side), a first contact hole CON1 is formed in the gate insulating film GSN. Further, above the common wires CL (liquid crystal layer side), a second contact hole CON2 is formed in the gate insulating film GSN.

As shown in FIG. 3, a semiconductor layer SEM, data signal lines DL, and a source electrode SM of a thin-film transistor TFT are formed on the gate insulating film GSN. A part of the data signal line DL (drain electrode) and a part of the source electrode SM are formed on the semiconductor layer SEM. A part of the source electrode SM is formed inside the first contact hole CON1 in the gate insulating film GSN, and makes contact with the end of the pixel electrode PIT. As a result, the source electrode SM and the pixel electrode PIT are electrically connected to each other.

As shown in FIG. 4, a connection electrode RSM is formed on the gate insulating film GSN and inside the second contact hole CON2. The connection electrode RSM makes contact with the common wire CL, so that the connection electrode RSM and the common wire CL are electrically connected to each other.

A protective insulation film PAS (second insulating film) is formed so as to cover the data signal line DL, the source electrode SM, and the connection electrode RSM. Above the common wire CL (liquid crystal layer side), a third contact hole CON3 is formed in the protective insulation film PAS. A common electrode CIT is formed on the protective insulation film PAS and inside the third contact hole CON3. As a result, a holding capacitance Cstg is formed between the pixel electrode PIT and the common electrode CIT. In addition, the common electrode CIT and the common wire CL are electrically connected to each other through the connection electrode RSM. A second alignment film AL2 is formed so as to cover the common electrode CIT. A second polarizing plate POL2 is formed on the back side of the second transparent substrate SUB2.

A black matrix BM and a color filter CF are formed on the back side of a first transparent substrate SUB1 (glass substrate). A surface of the color filter CF is covered with an overcoat film OC which is made of an organic material, and a first alignment film AL1 is formed on the overcoat film OC. A first polarizing plate POL1 is formed on an opposite side with the liquid crystal layer of the first transparent substrate SUB1. Note that when the semiconductor layer SEM is directly exposed to external light, the resistance may be reduced, and the holding characteristic of the liquid crystal display device LCD may be lowered, which may impede to display a good image. Therefore, the black matrix BM is formed at a position above the semiconductor layer SEM in the first transparent substrate SUB1. Further, the black matrix BM is disposed on a boundary between pixels of the color filter CF. As a result, since color mixing is prevented, which would otherwise be caused, when light of adjacent pixels are viewed from an oblique direction, a significant effect that a good image without smears is capable of be displayed can be obtained. However, when the width of the black matrix BM is too large, an aperture ratio and a transmittance may be lowered. Therefore, in a high-resolution liquid crystal display device, in order to realize performance with high brightness and low power consumption, the width of the black matrix BM is preferably set to the minimum width to an extent that the color mixing when viewed from an oblique direction does not occur. The black matrix BM is formed of a resin material or a metal material with a black pigment.

As shown in FIG. 3, the pixel electrode PIT is directly formed on the second transparent substrate SUB2. In each pixel, the pixel electrode PIT is connected to the source electrode SM of the thin-film transistor TFT through the first contact hole CON1 formed in the gate insulating film GSN. Further, in the region where the first contact hole CON1 is formed, the source electrode SM and the pixel electrode PIT overlap each other in a plan view. According to the above configuration, since the gate insulating film GSN is interposed between the pixel electrode PIT and the data signal line DL, it is possible to prevent a short circuit between the pixel electrode PIT and the data signal line DL. Further, since the pixel electrode PIT can be efficiently manufactured in the same process of forming the gate signal line GL, it can achieve to simplify the manufacturing process.

As shown in FIG. 3, in the region where the first contact hole CON1 is formed, the source electrode SM and the common electrode CIT overlap each other in a plan view. That is, the common electrode CIT is formed so as to cover the pixel electrode PIT, the source electrode SM, and the first contact holes CON1, and as compared with a conventional configuration, it is possible to increase the area occupied by the common electrode CIT in the pixel region. Accordingly, the aperture ratio of the pixel can be improved.

As shown in FIG. 4, the second contact hole CON2 and the third contact hole CON3 are arranged so as to overlap each other, in a plan view. Therefore, since the formation area of the contact hole can be reduced, the aperture ratio of the pixel can be improved. Further, since the common wire CL can be formed in the same process as the gate signal line GL, it can achieve to simplify the manufacturing process.

The transparent electrode material is not limited to Indium tin oxide (ITO), and may be Indium Zinc Oxide (IZO). The transparent electrode material is an oxide, and its thickness is set to be thin. In the present embodiment, since the first contact holes CON1, which is an opening in the gate insulating film GSN, has already been opened, the connection electrode RSM formed by the same process and made of the same material as the data signal line DL can be disposed above the common wire CL. Furthermore, the second contact hole CON2 is opened in the protective insulation film PAS, the connection electrode RSM and the common electrode CIT are electrically connected to each other, and the common electrodes CIT with high resistance can be electrically connected to the common wire CL which is a low resistance metal material. Therefore, a good picture quality can be realized even with a large screen. Further, the connection electrode RSM has been inserted, thereby improving an yield, since a thin and easily disconnected common electrode CIT can climb over a difference height of the protective insulation film PAS.

A method for manufacturing the TFT substrate in the liquid crystal display device LCD according to the present embodiment will be described.

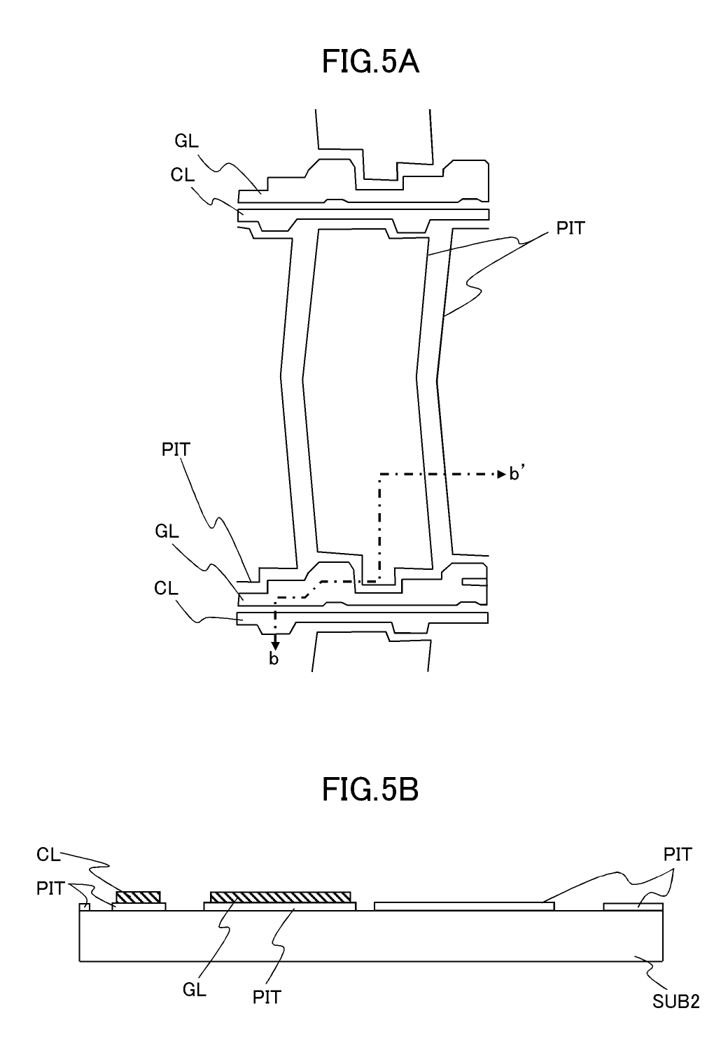

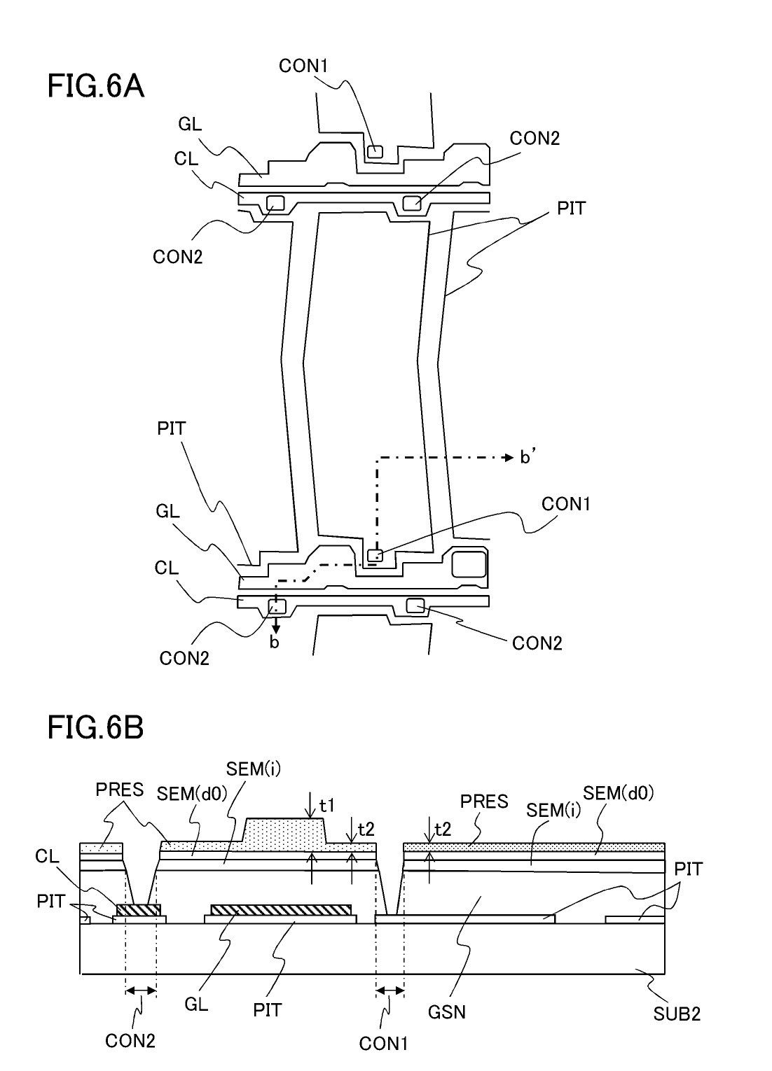

FIGS. 5 to 10 show manufacturing processes of a thin-film transistor TFT formed on a TFT substrate, a wiring region, and an opening. The manufacturing processes of the respective figures show a plan view of one pixel and a cross-section view taken along line b-b′ of the plan view. The respective figure excluding FIG. 6 show a plan view and a cross-sectional view in a state after a resist has been peeled off in each photoresist process.

FIG. 5A shows a plan view of one pixel after the end of a first photoresist process, and FIG. 5B shows a cross sectional view taken along line b-b′ of FIG. 5A.

A transparent electrode material ITO and low-resistance metal materials for a gate signal line GL and a common wire CL are successively formed on a second transparent substrate SUB2, and then the metal materials and the transparent electrode material ITO are processed in this order, so that a gate signal line GL, a common wire CL, and a pixel electrode PIT are formed by patterning. In the first photoresist process, since processing is performed using a halftone exposure mask, a photoresist having a binary thickness is further removed by ashing, and a thin resist is eliminated. For this reason, an opaque metal material on the pixel electrode PIT can be removed. By employing halftone exposure, the patterning of the common wire CL, the gate signal line GL, and the pixel electrode PIT can be formed in one photoresist process. The metal material may be, for example, a laminated film of copper Cu with a thickness from 100 nm to 300 nm and molybdenum Mo formed thereon. The metal material may also be a laminated film of molybdenum Mo and aluminum Al, a laminated film of titanium Ti and aluminum Al, an MoW alloy of molybdenum Mo and tungsten W, or the like.

FIG. 6A shows a plan view of one pixel after developing a photoresist in a second photoresist process and removing a semiconductor layer SEM and a gate insulating film GSN by etching, and FIG. 6B shows a cross-sectional view taken along line b-b′ of FIG. 6A.

The half tone exposure mask is used for second exposure. Therefore, after the development, the photoresist is divided into three regions, that is, a region where the thickness of the photoresist is t1, a region where the thickness is t2 smaller than t1, and a region where the photoresist is not formed. Since there is no resist in a region of a first contact hole CON1, by dry etching using SF6 gas, a semiconductor layer SEM and a gate insulating film GSN made of silicon nitride can be successively opened. Since the semiconductor materials of silicon nitride SiN and silicon have a high etching rate of the semiconductor layer SEM, the gate insulating film GSN consequently becomes tapered.

Next, ashing is performed to remove the photoresist PRES in the region where the thickness is t2. By this process, the photoresist remains only in the region where the thickness is t1, on the semiconductor layer SEM. The semiconductor layer SEM is subjected to dry etching in this state, so that only the photoresist PRES region with the thickness t1 is patterned into an island shape.

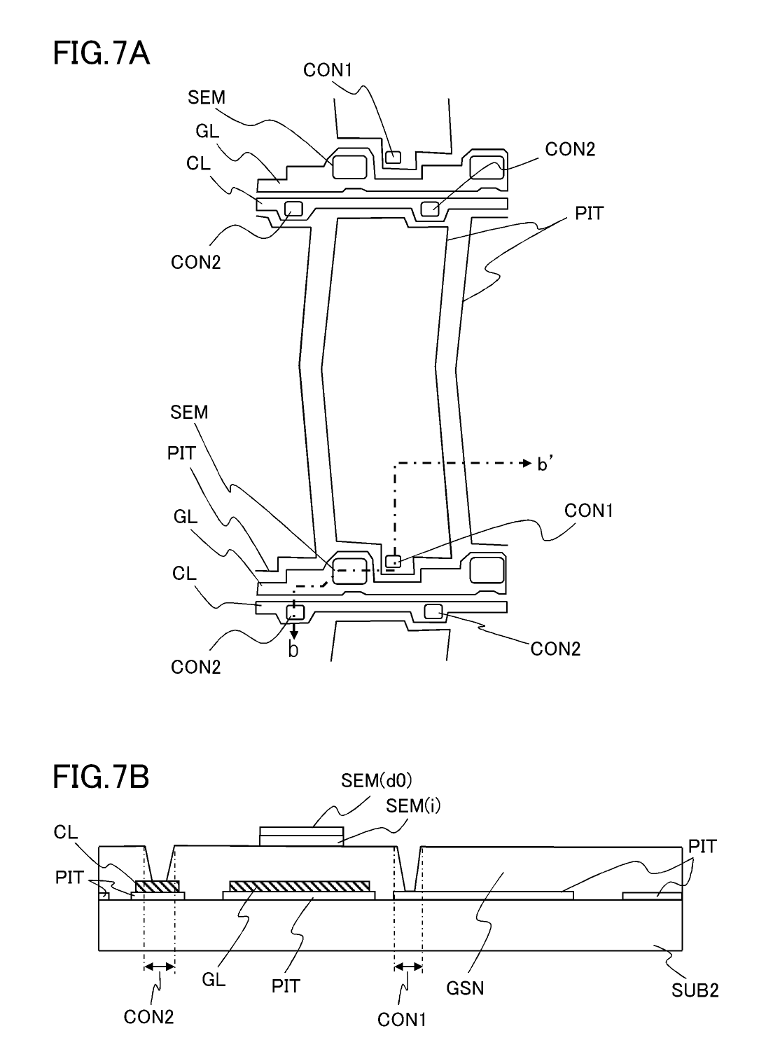

FIG. 7A shows a plan view of one pixel after the end of the second photoresist process, and FIG. 7B shows a cross-sectional view taken along line b-b′ of FIG. 7A.

Next, in the second photoresist process, the semiconductor layer SEM as the thin-film transistor TFT is patterned in an island shape, and a first contact hole CON1 and a second contact hole CON2 are formed in the gate insulating film GSN above the pixel electrode PIT and the common wire CL. By the photoresist process using the halftone exposure mask, two kinds of processing, that is, patterning the semiconductor layer SEM in the island shape and opening the first contact hole CON1 and the second contact hole CON2 are performed in one photoresist process.

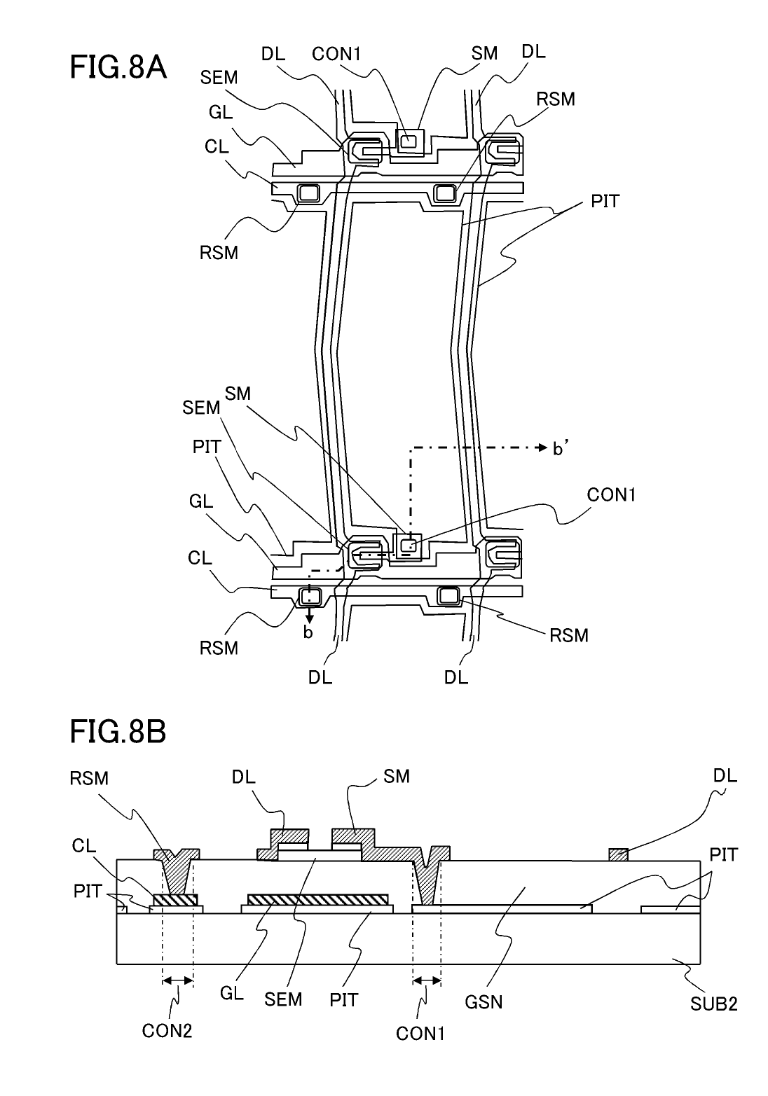

FIG. 8A shows a plan view of one pixel after the end of a third photoresist process, FIG. 8B shows a cross-sectional view taken along line b-b′ of FIG. 8A.

Next, a low-resistance metal material is deposited and is subjected to pattern processing. Thus, a data signal line DL, a source electrode SM, and a connection electrode RSM are patterned. The pixel electrode PIT and the source electrode SM are electrically connected to each other through the first contact hole CON1 opened in the gate insulating film GSN, and the common wire CL and the connection electrode RSM are electrically connected to each other through the second contact hole CON2 opened in the gate insulating film GSN. In the first contact hole CON1, since the source electrode SM is arranged so as to cover in a wider pattern than the first contact hole CON1, a good connection between the pixel electrode PIT and the source electrode SM can be established.

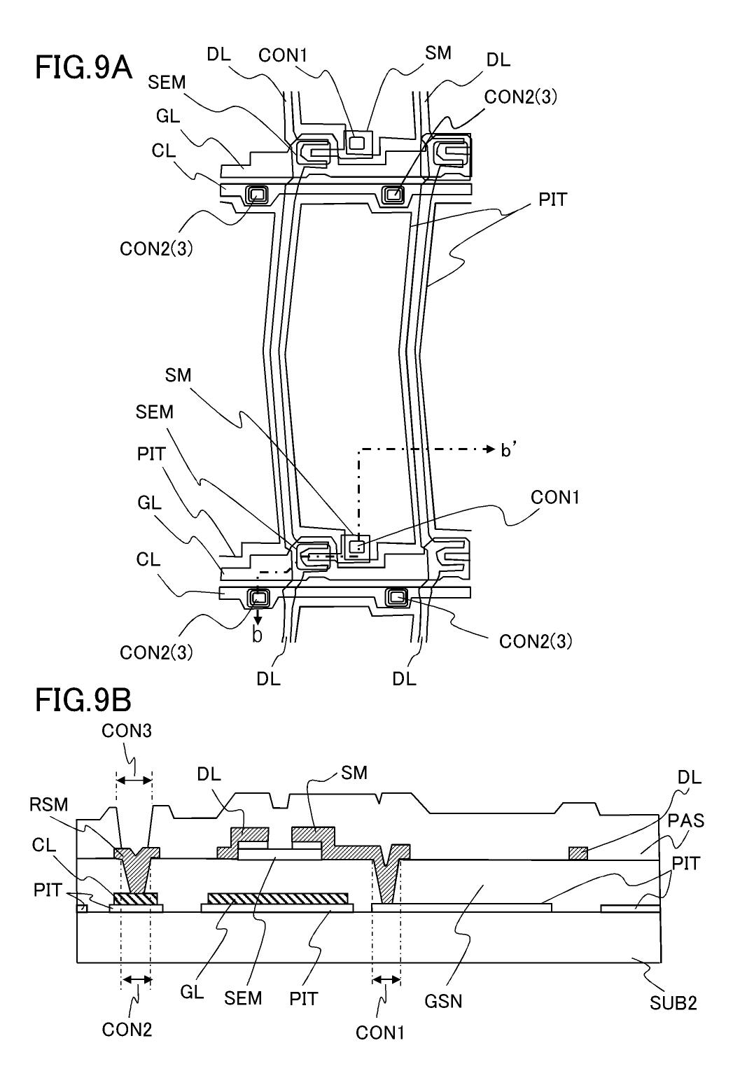

FIG. 9A shows a plan view of one pixel after the end of a fourth photoresist process, and FIG. 9B shows a cross-sectional view taken along line b-b′ of FIG. 9A.

Next, a protective insulation film PAS made of silicon nitride is formed, and the protective insulation film PAS is opened. A third contact hole CON3 is formed in the protective insulation film PAS on the connection electrode RSM that is electrically connected to the common wire CL.

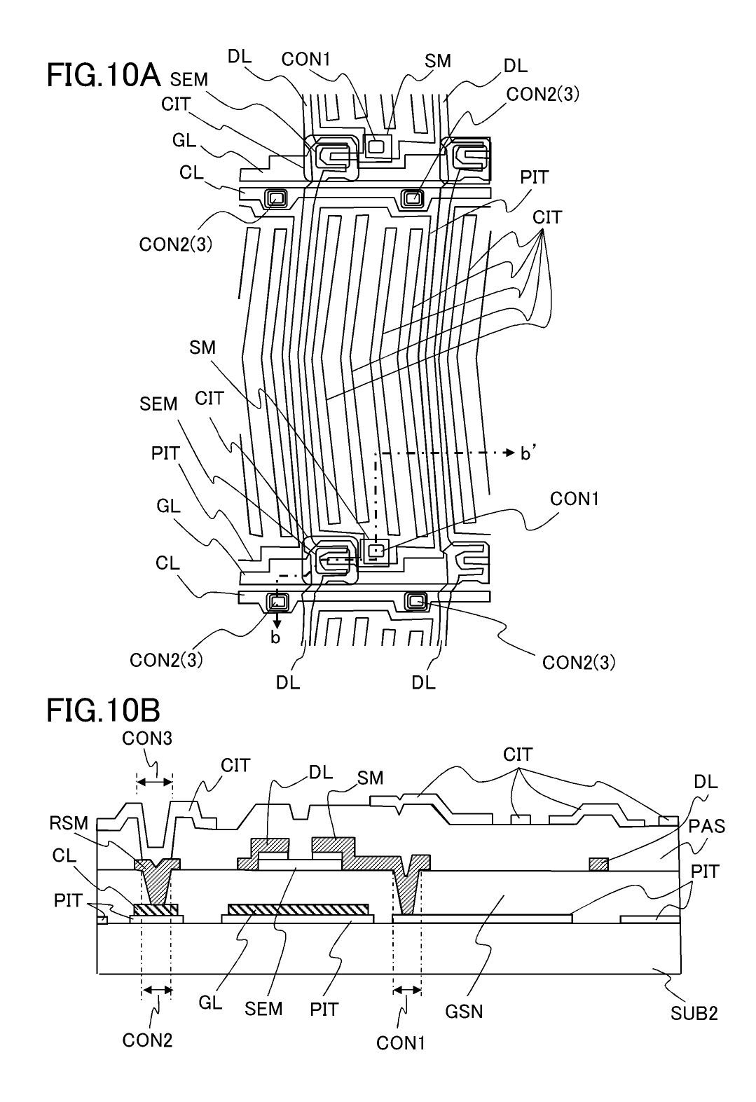

FIG. 10A shows a plan view of one pixel after the end of a fifth photoresist process, and FIG. 10B shows a cross-sectional view taken along line b-b′ of FIG. 10A.

Next, a transparent electrode material ITO is deposited and is subjected to pattern processing through the fifth photoresist process. Thus, a common electrode CIT which has a slit in the pixel and is arranged over a plurality of pixels is patterned.

With the above-described configuration, in the region where the thin-film transistor TFT is formed, the source electrode SM is connected via the first contact hole CON1 in the gate insulating film GSN. Since the protective insulation film PAS is formed on the source electrode SM, the common electrode CIT extends to the region, where the first contact hole CON1 is formed, of the source electrode SM and is arranged on the protective insulation film PAS. Therefore, the area occupied by the common electrode CIT in one pixel can be increased, and the aperture ratio can be improved. In addition, the common wire CL is electrically connected to the common electrode CIT through the third contact hole CON3 in the protective insulation film PAS on the connection electrode RSM. According to this manufacturing method, since the second contact hole CON2 in the gate insulating film GSN and the third contact hole CON3 in the protective insulation film PAS are formed in different photoresist processes, the yield of disconnection of the common wire CL and the common electrode CIT in the contact holes can be enhanced.

As described above, through the five photoresist processes, the TFT substrate of the liquid crystal display device LCD can be manufactured efficiently. Note that known manufacturing methods can be applied to the method for manufacturing the CF substrate of the liquid crystal display device LCD.

While there have been described what are at present considered to be certain embodiments of the application, it will be understood that various modifications may be made thereto, and it is intended that the appended claims cover all such modifications as fall within the true spirit and scope of the invention.

What is claimed is:

1. A liquid crystal display device comprising a pair of substrates, which are disposed opposite to each other with a liquid crystal layer interposed therebetween, wherein
one of the substrates includes:
a plurality of gate signal lines extending in a row direction;
a plurality of data signal lines extending in a column direction;
a plurality of pixel electrodes and a plurality of thin-film transistors, which are disposed according to a plurality of pixels arrayed in the row direction and the column direction;
a first insulating film formed between the plurality of pixel electrodes and the plurality of thin-film transistors; and
a common electrode disposed opposite to the plurality of pixel electrodes on a liquid crystal layer side,
the plurality of pixel electrodes are directly formed on a transparent substrate constituting the one of the substrates,
in each of the pixels, the pixel electrode is electrically connected to a conduction electrode of the thin-film transistor through a first contact hole formed in the first insulating film, and
the conduction electrode and the pixel electrode overlap each other in a plan view in a region where the first contact hole is formed.

2. The liquid crystal display device according to claim 1, wherein a part of the conduction electrode is formed in the first contact hole, and directly connected to the pixel electrode.

3. The liquid crystal display device according to claim 1, wherein
a second insulating film disposed between the plurality of thin-film transistors and the common electrode is further formed in the one of the substrates, and
the conduction electrode and the common electrode overlap each other in a plan view in the region where the first contact hole is formed.

4. The liquid crystal display device according to claim 1, wherein
the one of the substrates further includes a second insulating film disposed between the plurality of thin-film transistors and the common electrode and a plurality of common wires electrically connected to the common electrode, and
the plurality of common wires are electrically connected to the common electrode through a second contact hole formed in the first insulating film and a third contact hole formed in the second insulating film.

5. The liquid crystal display device according to claim 4, wherein the second contact hole and the third contact hole overlap each other in a plan view.

6. The liquid crystal display device according to claim 4, wherein
a connection electrode is formed in the second contact hole, and
the plurality of common wires are electrically connected to the common electrode through the connection electrode.

7. The liquid crystal display device according to claim 1, wherein
a plurality of transparent electrodes are directly formed on the transparent substrate,
the plurality of transparent electrodes include a plurality of first transparent electrodes and a plurality of second transparent electrodes,
the plurality of first transparent electrodes are formed as the plurality of pixel electrodes, and
the plurality of gate signal lines are directly formed on the plurality of second transparent electrodes.

8. The liquid crystal display device according to claim 4, wherein
a plurality of transparent electrodes are directly formed on the transparent substrate,
the plurality of transparent electrodes include a plurality of first transparent electrodes, a plurality of second transparent electrodes, and a plurality of third transparent electrodes,
the plurality of first transparent electrodes are formed as the plurality of pixel electrodes,
the plurality of gate signal lines are directly formed on the plurality of second transparent electrodes, and
the plurality of common wires are directly formed on the plurality of third transparent electrodes.

9. A method for manufacturing a liquid crystal display device, the method comprising:
forming a plurality of pixel electrodes on a transparent substrate;
forming a first insulating film such that the first insulating film covers the plurality of pixel electrodes;
forming a first contact hole in the first insulating film; and
forming a conduction electrode of a thin-film transistor on the first insulating film and in the first contact hole such that a part of the conduction electrode overlaps the pixel electrode in a plan view in a region where the first contact hole is formed.

10. The method for manufacturing a liquid crystal display device according to claim 9, wherein
in the forming of the first contact hole,
a semiconductor layer of the thin-film transistor and the first contact hole are formed in one photoresist process.

11. The method for manufacturing a liquid crystal display device, the method comprising:
forming a transparent electrode material on a transparent substrate;
forming a plurality of common wires, a plurality of gate signal lines, and a plurality of pixel electrodes by patterning the transparent electrode material;
forming a first insulating film such that the first insulating film covers the plurality of common wires, the plurality of gate signal lines, and the plurality of pixel electrodes;
forming a first contact hole and a second contact hole in the first insulating film;
forming a conduction electrode of a thin-film transistor on the first insulating film and in the first contact hole;
forming a connection electrode on the first insulating film and in the second contact hole;
forming a second insulating film such that the second insulating film covers the thin-film transistor and the connection electrode;
forming a third contact hole in the second insulating film above the connection electrode; and
forming a common electrode on the second insulating film and in the third contact hole such that the common electrode covers the conduction electrode and the pixel electrode in a plan view in a region where the first contact hole is formed, and such that the common electrode covers the connection electrode in a plan view in a region where the third contact hole.

12. The method for manufacturing a liquid crystal display device according to claim 11, wherein
in the forming of the first contact hole and the second contact hole,
a semiconductor layer of the thin-film transistor, the first contact hole, and the second contact hole are formed in one photoresist process.
